(19) United States
(12) Patent Application Publication
(10) Pub. No.: US 2006/0147658 A1
(43) Pub. Date: Jul. 6, 2006

(54) Ink-jet recording medium

(75) Inventors: Joseph Hubertus Olijve, Kaatsheuvel (NL); Bernadette Catharina A. M. van der Velden-Schuermans, Udenhout (NL); Iskandar Gandasasmita, Tilburg (NL); Yoichiro Kamiyama, Tilburg (NL); Akira Kase, Tilburg (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/305,313

(22) Filed: Dec. 16, 2005

Related U.S. Application Data
(63) Continuation of application No. PCT/NL04/00263, filed on Apr. 20, 2004.

(30) Foreign Application Priority Data
Jun. 18, 2003 (EP) 03076901.2

(51) Int. Cl. B41M 5/00

(52) U.S. Cl. 428/32.24

(57) ABSTRACT

The present invention relates to a recording medium, in particular an ink-jet recording medium of photographic quality that has excellent ink absorption speed, good drying characteristics and a good image printing quality. According to the present invention, an ink-jet recording medium is provided, comprising a support to which at least an underlayer and an overlayer is supplied in which the overlayer contains at least one specific type of modified gelatin. The present invention is further directed to methods for obtaining and using such a medium.

### FIELD OF INVENTION

The present invention relates generally to a recording medium, in particular an ink-jet recording medium of photographic quality that has excellent ink absorption speed, good drying characteristics and a good image printing quality, as well as to methods for preparing such media.

### BACKGROUND OF THE INVENTION

In a typical ink-jet recording or printing system, ink droplets are ejected from a nozzle at high speed towards a recording element or medium to produce an image on the medium. The ink droplets, or recording liquid, generally comprise a recording agent, such as a dye, and a relatively large amount of solvent in order to prevent clogging of the nozzle. The solvent, or carrier liquid, typically is made up of water and organic material such as monohydric alcohols and the like. An image recorded as liquid droplets requires a receptor on which the recording liquid dries quickly without running or spreading. High quality image reproduction using ink-jet printing techniques requires receptor substrates, typically sheets of paper or opaque or transparent film, that readily absorb ink droplets while preventing droplet diffusion or migration. Good absorption of ink encourages image drying while minimizing dye migration by which good sharpness of the recorded image is obtained.

There are in general two approaches for producing ink-jet recording media with photographic quality and good drying properties.

One known approach is to provide a substrate with a porous layer, which can act as the ink-receiving layer. However, this known technique may give problems as to the gloss of the paper. In specific embodiment of the known technique of substrates provided with a porous layer, there is provided on top of the porous layer a gloss enhancing layer. In this microporous type, the microporous film has as the primary function to absorb the ink solvent. The typical microporous film suitable for this purpose is described inter alia in U.S. Pat. No. 4,833,172, U.S. Pat. No. 4,861,644, U.S. Pat. No. 5,326,391

Another approach for producing ink-jet recording media with photographic quality and good drying properties is the so called “non-microporous film type”, also known as “swellable type”, as proposed in several patent publications such as EP-A-806 299 and JP-A-22 76 670. For this type of ink-jet recording medium, at least one ink receptive layer is coated on a support such as a paper or a transparent film. The ink receptive layer typically contains various proportions of water soluble polymers and fillers. The proportions of these components affect the properties of the coated layers, in particular ink absorption properties and the gloss quality appearance of the ink-jet media.

One of the important properties of an ink-jet receptive coating formulation is the liquid absorptivity. The majority, if not all, of the ink solvent has to be absorbed by the coating layer itself. Only when paper or cloth or cellulose is used as a support, some part of the solvent may be absorbed by the support. It is thus clear that both the water soluble polymer and the filler should have a significant ability to absorb the ink solvent.

U.S. Pat. No. 2,002/142141 discloses an image-receiving layer, which contains at least one water soluble polymer like polyvinyl alcohol, that swells when ink-jet ink is attached to the image-receiving layer. Improved performance with respect to durability, scuff resistance and image fidelity is said to be obtained.

In EP-A-875 393 a sheet for ink-jet recording is disclosed in which microporous polysaccharide particles are provided in an ink-receiving layer comprising for example polyvinyl alcohol. The microporous particles are said to give very good ink receptivity and also to provide good sheet feeding property in ink-jet printers.

DE-A-228 48 23 and U.S. Pat. No. 4,379,804 disclose methods in which gelatin is used in ink-receiving layers of ink-jet receiving sheets. From these documents, it has become clear that gelatin has an advantageous function for the absorption of ink solvents. The gelatin is said to improve smudge resistance, increase the definition quality, give high gloss, fast water absorbing properties, easy to achieve high water resistance and good dye fading resistance.

There are at least two major disadvantages to a gelatin-based coating, which are not much addressed in the existing art. These disadvantages include curl and brittleness of the coating.

Various countermeasures have been suggested to overcome these problems.

In WO-A-00/53406 the use of at least one plasticizer selected from the group comprising 2-pyrrolidone and its derivatives, or urea and its derivatives is described to overcome the curl and brittleness of this type coating.

Besides the curl and brittleness, other problems are encountered using ink receiving layers based on gelatin or gelatin mixtures with water soluble polymers. These are problems like beading, bleed and matte appearance at high densities. To overcome these problems various solutions have been proposed.

U.S. Pat. No. 6,183,844 describes the use of highly filled multilayers to improve bleed and wet smear resistance.

EP-A-0 742 109 describes the use of a combination of anionic and cationic fluorine containing surfactants in order to improve dot reproduction especially for graphic art applications.

BP-A-1 080 936 describes the use of a non-ionic surfactant giving a lower surface tension in the layer of an ink receptive multilayer farthest from the support and a second non ionic surfactant giving a higher surface tension in the layer nearer to the support material. Improved gloss and bleed is claimed.

EP-A-1 334 839 (published after the priority date of the present application) describes an ink recording element comprising a hydrophilic absorbing layer, which comprises a natural or synthetic polymer, such as modified gelatins or gelatin derivatives.

U.S. Pat. No. 4,946,741 describes an inkjet recording sheet comprising a transparent support having thereon an ink recording layer comprising a polyalkylene oxide and an aminogroup-deactivated gelatin derivative, such as acetyl gelatins, pithaloyl gelatins, malenoyl gelatins, benzoyl gelatins, succinoyl gelatins and methylurea gelatins.

EP-A-O 641 669 describes a recording material, which may comprise an outermost hydrophilic water-permeable layer that may contain inter alia a gelatin derivative, such as acetylated gelatin.

Although some improvement can be obtained by these known methods, there remains a need for low cost ink-jet material with good image printing quality, good drying properties, improved curl and brittleness, having at the same time good behaviour on bleed,. beading and matte appearance at high density parts. It is towards fulfilling this need that the present invention is directed.

### SUMMARY OF THE INVENTION

The object of the present invention is thus to provide an ink-jet recording medium having good drying properties, said recording medium more in particular being suited to produce images of photographic quality.

It is another object of the present invention to provide an ink jet recording medium with reduced brittleness at low humidity's and excellent curl behaviour.

It is a further object of this invention, to provide an ink jet recording medium which gives no beading and has no matte appearance at high densities and has good bleeding properties

It has been found that these objectives can be met by providing an ink-jet recording medium comprising a support and an ink receiving layer adhered to said support, where the ink receiving Layer is a multilayer comprising at least an underlayer and an overlayer in which the overlayer comprises at least one type of modified gelatin.

### DETAILED DESCRIPTION

The invention is directed to a recording medium comprising a support and an ink receiving layer adhered to said support, where the ink receiving layer is a multilayer comprising at least an underlayer and at least an overlayer in which the overlayer comprises at least one specific type of modified gelatin. This invention is also related to the manufacturing of such a recording medium and the use of this medium. Although the invention is described herein with particular reference to inkjet printing, it will be apparent to the skilled person that the high quality recording media of the present invention are not limited to inkjet recording media (viz. media suitable to be printed on using ink-jet printers), but that it is within the scope of the present invention to provide recording media that. are suitable for creating high quality images by using other techniques as well, such as Giclée printing, colour copying, screen printing, gravure, dye-sublimation, flexography, and the like.

In the conventional media for ink jet application comprising at least one ink receiving layer based on a water soluble polymer, such as gelatin, PVA, PEO, hydroxyethylcellulose and the like and mixtures of these polymers, it is possible to obtain good drying characteristics but it is difficult to obtain an image with photographic quality due to problems like bleed, beading, finger print smearing and matte appearance at high densities. We have now found surprisingly that these negative properties can be improved very much by using a medium on which the ink receiving layer is a multilayer, at least comprising an underlayer and an overlayer. In this type of ink receiving layer, the underlayer especially determines the physical and ink receiving properties, while the overlayer determines the surface properties like beading and gloss. The overlayer of this invention comprises a modified gelatin, and may further comprise water insoluble particles inter alia to regulate the slip behaviour and optionally one or more water soluble polymers, surfactants and other additives to optimise the surface properties.

The term “modified gelatin” as used herein, refers to gelatin compounds in which at least part of the NH₂ groups is chemically modified. A variety of modified gelatins can be used in the overlayer. Good results are obtained, when at least 30% of the NH₂ groups of the gelatin is modified by a condensation reaction with a compound having at least one carboxylic group as described among others in DE-A-19721238. The compound having at least one carboxylic group can have an other functional group like a second carboxylic group and a long aliphatic tail, which in principle is not modified. Long tail in this context means from at least 5 to as much as 20 C atoms. This aliphatic chain can be modified still to adjust the properties like water solubility and ink receptivity. Specially preferred gelatins of this type are succinic acid modified gelatins in which the succinic acid moiety contains an aliphatic chain from at least 5 to 20 carbon-atoms, where the chain can still be modified to a certain extend to adjust the water soluble properties or ink receptive properties. Most preferred is the use of dodecylsuccinic acid modified gelatin, in which at least 30% of the NH₂ groups of the gelatin have been modified with said dodecylsuccinic acid.

Another method for obtaining modified gelatin is described in EP-A-0576911, where said gelatin is formed from gelatin containing pendant amine groups and pendant carboxylic groups wherein at least one amine group of said gelatin is modified to form an amide of the formula —NHCOR. The process typically involves reaction of an amine group with an activated carboxyl, i.e. a reaction product of a carboxyl activating agent and carboxylic acid, i.e., RCOOH wherein R represents substituted or unsubstituted alkyl of 1-10 carbons, substituted or unsubstituted aryl of 6-14 carbons, or substituted or unsubstituted arylalkyl of 7-20 carbons.

Other suitable methods are described by V.N. Izmailova, et at. (Colloid Journal, vol. 64, No. 5, 2002, page 640-642), and by O. Toledano, et al. (Journal of Colloid and Interface Science 200, page 235-240) wherein hydrophobic groups are attached to gelatin molecules by reacting gelatin with respectively N-hydroxysuccinimide ester of caprylic acid and N-hydroxysuccinimide ester of various fatty acids (C₄-C₁₆).

Other modified gelatins giving good results are gelatins modified to have quaternairy ammonium groups. An example of such a gelatin is the “Croquat™” gelatin produced by Croda Colloids Ltd. Still another modified gelatin known in the common gelatin technology, such as phtalated gelatin and acetylated gelatins are also suitable to be used in this invention.

The modified gelatin can be used alone or in combination with another water soluble polymer. Examples of these polymers include: fully hydrolysed or partially hydrolysed polyvinyl alcohol, hydroxyethyl cellulose, methyl cellulose, hydroxypropyl cellulose, polyvinylpyrolidone, any gelatin whether lime-processed or acid processed made from animal collagen, preferably gelatin made from pig skin, cow skin or cow bone, polyethylene oxide, polyacrylamide, and the like. The modified gelatin or mixtures of modified gelatin and water soluble polymer are preferably applied to the substrate in an amount ranging from 0.5 to 5 g/m² and more preferably from 0.5 to 3 g/m². A suitable amount of the water soluble polymer in said mixture is between 0 and 76 wt % of the amount of the modified gelatin. In case said water soluble polymer amount is higher than 75 wt %, the advantages of the modified gelatin may become less pronounced. The mere application of the modified gelatin or mix of modified gelatin and water soluble polymers improves the characteristics with respect to drying and finger smearing properties. A further improvement of above mentioned properties can be obtained by including in the overlayer a fluorosurfactant in the amount between 2.5 mg/m² and 250 mg/m². It was found that this kind of surfactants improves amongst others the gloss and beading. Beading is defined as the phenomenon that large ink dots become visible on the printed image. The mechanism of “beading” is not clear yet. One hypothesis is that several small ink drops coalesce with each other on the surface of the ink jet media and form large ink droplets.

The term “fluorosurfactant” as used herein, refers to surfactants (viz. molecules having a hydrophilic and a hydrophobic part) that contain fluorcarbon or a combination between fluorcarbon and hydrocarbon as the hydrophobic part. Suitable fluorosurfactants may be anionic, non-ionic or cationic. Examples of suitable fluorosurfactants are: fluoro C₂-C₂₀ alkylcarboxylic acids, disodium N-perfluorooctanesulfonyl glutamate, sodium 3-(fluoro-C₆-C₁₁ alkylaxy)-1-C₃-C₄ alkyl sulfonates, sodium-3-(omega -fluoro-C₆-C₈ alkanoyl-N-ethylamino)-1-propane sulfonates, N-[3-(perfluorooctane-sulfonamide)-propyl]-N,N-dimethyl-N-carboxymethylene ammonium betaine, perfluoro C₇-C₁₃ alkyl carboxylic acids, perfluorooctane sulfonic acid diethanolamide, Li, K and Na perfluoro C₄-C₁₂ alkyl sulfonates, Li, K and Na N-perfluoro C₄-C₁₈ alkane sulfonyl-N-alkyl glycine, fluorosurfactants commercially available under the name Zonyl® (produced by E.I. Du Pont) that have the chemical structure of R_{f}CH₂CH₂SCH₂CH₂CO₂Li or R_{f}CH₂CH₂O(CH₂CH₂O)ₓH wherein R_{f}=F(CF₂CF₂)₃₋₈ and x is 0 to 26, N-propyl-N-(2-hydroxyethyl)perfluorooctane sulfonamide, 1,4-bis(fluoroalkyl)-2-[2-N,N,N-trialkylammonium)alkyl amino]butanedioate, perfluoro C₆-C₁₀ alkylsulfonamide propyl sulfonyl glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine.

Also useful are the fluorocarbon surfactants described e.g. in U.S. Pat. No. 4,781,985 and in U.S. Pat. No. 5,084,340. Preferably the fluorosurfactant is chosen from Lit K and Na N-perfluoro C4-C₁₋₃ alkane sulfonyl-N-alkyl glycine, 1,4-bis(fluoroalkyl)-2-[2-(N,N,N-trialkylammonium alkyl amino]butanedioate and fluorosurfactants commercially available under the name Zonyl® produced by E.I. Du Pont) that have the chemical structure of R_{f}CH₂CH₂SCH₂CH₂CO₂Li or R_{f}CH₂CH₂O(CH₂CH₂O)ₓH wherein R_{f}═F(CF₂CF₂)₃₋₈ and x is 0 to 25. Beside the modified gelatin or modified gelatin/water soluble polymer mixture and fluorosurfactant it may be desirable to add in the overlayer an anti-blocking agent to prevent image transfer when several printed inkjet mediums are piled up. Very suitable anti-blocking agents (also known as matting agents) have a particle size from 1 to 20 μm, preferably between 2 and 10 μm. The amount of matting agent is from 0.01 to 1 g/m², preferably from 0.02 to 0.5 g/m². The matting agent can be defined as particles of inorganic or organic materials capable of being dispersed in a hydrophilic organic colloid. The inorganic matting agents include oxides such as silicon oxide, titanium oxide, magnesium oxide and aluminium oxide, alkali earth metal salts such as barium sulphate, calcium carbonate, and magnesium sulphate, light-insensitive silver halide particles such as silver chloride and silver bromide (each of which may contain a small amount of an iodine atom), and glass particles. Besides these substances one may select inorganic matting agents which are disclosed in West German Patent No. 2,529,321, British Patent Nos. 760,775 and 1,260,772, U.S. Pat. Nos. 1,201,906, 2,192,241, 3,053,662, 3,062,649, 3,257,296, 3,322,555, 3,353,958, 3,370,951, 3,411,907, 3,437,484, 3,523,022, 3,615,554, 3,635,714, 3,769,020, 4,021,245 and 4,029,504. The organic matting agents include starch, cellulose esters such as cellulose acetate propionate, cellulose ethers such as ethyl cellulose, and synthetic resins. The synthetic resins are water insoluble or sparingly soluble polymers which include a polymer of an alkyl(meth)acrylate, an alkoxyalkyl(meth)acrylate, a glycidyl(meth)acrylate, a (meth)acrylamide, a vinyl ester such as vinyl acetate, acrylonitrile, an olefin such as ethylene, or styrene and a copolymer of the above described monomer with other monomers such as acrylic acid, methacrylic acid, alpha, beta-unsaturated dicarboxylic acid, hydroxyalkyl(meth)acrylate, sulfoalkyl(meth)acrylate and styrene sulfonic acid. Further, a benzoguanamin-formaldehyde resin, an epoxy resin, nylon, polycarbonates, phenol resins, polyvinyl carbazol or polyvinylidene chloride can be used. Besides the above are used organic matting agents which are disclosed in British Patent No. 1,055,713, U.S. Pat. Nos. 1,939,213, 2,221,873, 2,268,662, 2,322,037, 2,376,005, 2,391,181, 2,701,245, 2,992,1011 3,079,257, 3,262,782, 3,443,946, 3,516,832, 3,539,344,554, 3,591,379, 3,754,924 and 3,767,448, Japanese Patent O.P.I. Publication Nos. 49-106821/1974 and 57-14835/1982. These matting agents may be used alone or in combination.

The overlayer may optionally include thickener agents, biocides crosslinking agents and further various conventional additives such as colorants, colored pigments, pigment dispersants, mold lubricants, permeating agents, fixing agents for ink dyes, UV absorbers, anti-oxidants, dispersing agents, anti-foaming agents, leveling agents, fluidity improving agents, antiseptic agents ,brightening agents, viscosity stabilizing and/or enhancing agents, pH adjusting agents, anti-mildew agents, anti-fungal agents, agents for moisture-proofing, agents for increasing the stiffness of wet paper, agents for increasing the stiffness of dry paper and anti-static agents.

The above-mentioned various additives can be added ordinarily in a range of 0 to 10 weight % based on the solid content of the ink receiving layer composition.

A swellable ink receiving layer is preferred, since it was found that this provides a better light fastness property for an image printed thereon compared to the microporous type.

The underlayer typically comprises gelatin and a hydrophilic polymer and optionally additives to adjust the physical properties. This swellable underlayer determines mainly the physical properties like water uptake, drying speed, brittleness and curl.

There is a variety of gelatins, both non-modified as well as modified gelatins which can be used in the underlayer. Examples of non-modified gelatins are alkali-treated gelatin (cattle bone or hide gelatin), acid-treated gelatin (pigskin, cattle/pig bone gelatin), or hydrolyzed gelatin. Examples of modified gelatins are acetylated gelatin, phthalated gelatin, quaternary ammonium modified gelatin, et cetera. These gelatins can be used singly or in combination for forming the underlayer. Acid and alkali treated gelatins are preferred.

Water soluble polymers suitable to be mixed with the (modified) gelatin include fully hydrolysed or partially hydrolysed polyvinyl alcohol (PVA), carboxylated polyvinyl alcohol, hydroxyethyl cellulose, methyl cellulose, hydroxypropyl cellulose, carboxymethyl cellulose, casein, gum arabic, polyacrylic acid and its copolymers or terpolymers, polymethylacrylic acid and its copolymers or terpolymers, and any other polymers, which contain monomers of carboxylic acids such as acrylic acid, methacrylic acid, maleic acid and crotonic acid, polyvinylpyrolidone (PVP), polyethylene oxide, polyacrylamide, 2-pyrrolidone and its derivatives such as N(2-hydroxyethyl)-2-pyrrolidone and N-cyclohexyl-2-pyrrolidone, urea and its derivatives such as imidazolidinyl urea, diazolidinyl urea, 2-hydroxyethylethylene urea, and ethylene urea.

Most of the water soluble polymers have very limited compatibility with gelatin. These polymers include fully hydrolyzed or partially hydrolyzed polyvinyl alcohol hydroxyethyl cellulose, methyl cellulose, hydroxypropyl cellulose, polyethylene oxide, polyacrylamide, and the like. When a solution of gelatin in water is mixed with a solution in water of one of the above described polymers, micro or macro phase separation occurs in solution which persists in the dried coating. The dried coating exhibits high haze, low transparency, and low gloss. By applying the overlayer of the invention on such an underlayer, it will improve the appearance significantly. It is however better to use the inventive overlayer on an underlayer in which no phase separation between the gelatin and the water soluble polymer occurs. The system of a mixture of gelatin and a water soluble polymer is very well illustrated by means of a gelatin/PEO mixture as example.

A homogeneous gelatin PEO mixture, i.e. a mixture where no phase separation occurs, may be obtained by adjusting the pH of the mixture. However there is no unique rule to determine the pH at which there is no phase separation. The best way is to follow the practical approach by making the required mixture of gelatin and water soluble polymer in water and adding alkali or acid until a homogeneous solution is obtained. The suitable pH range mainly depends on the gelatin type used and type of the water soluble polymer. It was found that acid treated gelatins having an iso-electric-point (IEP) of between 6.5 and 11 give a homogeneous solution with polyethylene oxide (PEO) at a pH below 4.5. At pH between 4.5 and 10, the mixture remains turbid, which indicate that the mixture is not homogeneous. At a pH higher than 10, a homogeneous solution can be obtained. For a lime treated gelatin, that has a typical IEP value of between 4 and 6.5, a homogeneous mixture between gelatin and PEO can be obtained at a broader pH ranges, i.e. at a pH value lower than 5 or at a pH value higher than 6.5.

In addition to the above mentioned pH adjustment, we have now found, that it is not only important to have a homogeneous solution, but it is also beneficial to have a molecular weight of PEO of at least 100 000. A lower MW might also give satisfactory results, but in general most of the important properties, like curling, drying speed and brittleness improve when using a high MW PEO. In addition to this, it appeared to be beneficial to use an underlayer comprising various layers, in which the various layers have a different gelatin/PEO ratio. We have found that a low gelatin/PEO ratio in the layer adjacent to the overlayer and a higher gelatin/PEO ratio at the layers nearer to the support have a beneficial effect on properties like bleeding and beading. More specifically gelatin/PEO ratio's (wt./wt.) in the layer nearest to the overlayer preferably vary between in 1/1 to 4/1 and the gelatin/PEO ratios (wt./wt.) in the layers nearest to the support should vary between 2/1 and 10/1 with the condition, that the gelatin/PEO ratio of the layer adjacent to the overlayer is always lower, than the ratio of the other gelatin-PEO layers. When using more gelatin-PEO layers in the underlayer it is further beneficial to use a gradient for the gelatin/PEO ratio, meaning, that the gelatin/PEO ratio is lowest in the layer adjacent to the overlayer and said ratio is highest in the layer most near to the substrate.

The homogeneous gelatin-PEO solution of the underlayer, which is supplied to the substrate has a gelatin concentration between 5 and 20 wt. %.

It has been found by the present inventors that one may substitute the PEO with other water soluble polymers mentioned above such as PVP or PVA or a mixture between two or more water soluble polymers such as PEO and PVP. The ratio between the gelatin and said water soluble polymer(s) should be in the same ranges as it is described above for gelatin-PEO system.

The gelatin is preferably used in a total amount of from 1 to 30 g/m², and more preferably from 2 to 20 g/m². The amount of hydrophilic polymer more specifically the amount of PEO used in a certain formulation can be easily calculated from the indicated amount of gelatin and is typically in the range from 100 mg/m² to 30 g/m² and more preferably between 200 mg/m² and 20 g/m². When preparing the ink-jet-receiving sheet by coating a plurality of ink receiving layers, each ink-receiving layer preferably comprises an amount of gelatin ranging from 0.5 to 10 g/m².

If desired, the gelatin can be cross-linked in the image-recording elements of the present invention in order to impart mechanical strength to the layer. This can be done by any cross-linking agent known in the art.

For gelatin, there. is a large number of known cross-linking agents-also known as hardening agents. Examples of the hardener include aldehyde compounds such as formaldehyde and glutaraldehyde, ketone compounds such as diacetyl and chloropentanedion, bis (2-chloroethylurea), 2-hydroxy-4,6-dichloro-1,3,5-triazine, reactive halogen-containing compounds disclosed in U.S. Pat. No. 3,288,775, carbamoyl pyridinium compounds in which the pyridine ring carries a sulphate or an alkyl sulphate group disclosed in U.S. Pat. No. 4,063,952 and U.S. Pat. No. 5,529,892, divinylsulfones, and the like. These hardeners can be used singly or in combination. The amount of hardener used, preferably ranges from 0.1 to 10 g, and more preferably from 0.1 to 7 g based on 100 g of gelatin contained in the ink-receiving layer.

The homogeneous aqueous solution of the underlayer may further contain the following ingredients in order to improve the ink receiving layer properties with respect to ink receptivity and strength:

One or more plasticizers, such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, N-methyl-2-pyrrolidone, N-vinyl-2-pyrrolidone, and polymer lattices with low Tg-value such as polyethylacrylate, polymethylacrylate and the like.

One or more fillers; both organic and inorganic particles can be used as fillers. Useful filler examples are represented by silica (colloidal silica), alumina or alumina hydrate (aluminazol, colloidal alumina, a cat ion aluminum oxide or its hydrate and pseudo-boehmite), a surface-processed cat ion colloidal silica, aluminum silicate, magnesium silicate, magnesium carbonate, titanium dioxide, zinc oxide, calcium carbonate, kaolin, talc, clay, zinc carbonate, satin white, diatomaceous earth, synthetic amorphous silica, aluminum hydroxide, lithopone, zeolite, magnesium hydroxide and synthetic mica. Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefins, polysilicones, guanamine resins, polytetrafluoroethylene, elastomeric styrene-butadiene rubber (SBR), urea resins, urea-formalin resins. Such organic and inorganic fillers may be used alone or in combination.

One or more mordants. Mordants may be incorporated in the ink-receptive layer of the present invention. Such mordants are represented by cationic compounds, monomeric or polymeric, capable of completing with the dyes used in the ink compositions. Useful examples of such mordants include quaternary ammonium block copolymers. Other suitable mordants comprise diamino alkanes, ammonium quaternary salts and quaternary acrylic copolymer latexes. Other suitable mordants are fluoro compounds, such as tetra ammonium fluoride hydrate, 2,2,2-trifluoroethylamine hydrochloride, 1-(alpha, alpha. alpha -trifluoro-m-tolyl) piperazine hydrochloride, 4-bromo-alpha, alpha, alpha-trifluoro-o-toluidine hydrochloride, difluorophenylhydrazine hydrochloride, 4-fluorobenzylamine hydrochloride, 4-fluoro-alpha, alpha-dimethylphenethylamine hydrochloride, 2-fluoroethylaminehydrochloride, 2-fluoro-1-methyl pyridinium-toluene sulfonate, 4-fluorophenethylamine hydrochloride, fluorophenylhydrazine hydrochloride, 1-(2-fluorophenyl) piperazine monohydrochloride, 1-fluoro pyridinium trifluoromethane sulfonate.

One ore more conventional additives, such as:
pigments: white pigments such as titanium oxide, zinc oxide, talc, calcium carbonate and the like; blue pigments or dyes such as cobalt blue, ultramarine or phthalocyanine blue; magenta pigments or dyes such as cobalt violet, fast violet or manganese violet;
biocides;
pH controllers;
preservatives;
viscosity modifiers;
dispersing agents;
UV absorbing agents;
brightening agents;
anti-oxidants;
antistatic agents; and/or
anionic, cationic, non-ionic, and/or amphoteric surfactants, typically used in amounts ranging from 0.1 to 1000 mg/m², preferably from 0.5 to 100 mg/M².

These additives may be selected from known compounds and materials in accordance with the objects to be achieved.

The above-mentioned additives (plasticizers, fillers/pigments, mordants, conventional additives) may be added in a range of 0 to 30% by weight, based on the solid content of the water soluble polymers and/or gelatin in the underlayer.

The particle sizes of the non water-soluble additives should not be too high, since otherwise a negative influence on the resulting surface will be obtained. The used particle size should therefore preferably be less than 10 μm, more preferably 7 μm or less. The particle size is preferably above 0.1 μm, more preferably about 1 μm or more for handling purposes.

In another embodiment of this invention the beneficial effects of the modified gelatin and the fluorosurfactant is generated by applying these compounds in a separate overlayer coating, meaning, that also the overlayer is a multilayer. In this case it is preferable to have the fluorosurfactant in a coating layer farthest away from the substrate and the modified gelatin applied under this coating.

The resulting formulation of overlayer(s) and underlayer or underlayers can be coated consecutively or simultaneously to a support by any method known in the art. The coating methods are for example, a curtain coating, an extrusion coating, an air-knife coating, a slide coating, a roll coating method, reverse roll coating, dip coating processes and a rod bar coating.

The support used in this invention may suitably be selected from a paper, a photographic base paper, a paper coated on both sides with a polymer layer, pigment coated paper, a synthetic paper or a plastic film in which the top and back coatings are balanced in order to minimise the curl behaviour.

Examples of the material of the plastic film are polyolefin's such as polyethylene and polypropylene, vinyl copolymers such as polyvinyl acetate, polyvinyl chloride and polystyrene, polyamide such as 6,6-nylon and 6-nylon, polyesters such as polyethylene terephthalate, polyethylene-2 and 6-naphthalate and polycarbonate, and cellulose acetates such as cellulose triacetate and cellulose diacetate. The support may be subjected to a corona treatment in order to improve the adhesion between the support and the ink receiving layer. Also other techniques, like plasma treatment can be used to improve the adhesion.

The swellable ink-receiving layer has a dry thickness from 1 to 50 micrometers, preferably from 5 to 25 and more preferably between 8 and 20 micrometers. If the thickness of said ink receiving layer is less than 1 micrometer, adequate absorption of the solvent will not be obtained. If, on the other hand, the thickness of said ink receiving layer exceeds 50 micrometers, no further increase in solvent absorptivity will be gained.

The present invention will be illustrated in more detail by the following non-limiting examples. Unless stated otherwise, all ratios given are based on weight.

### EXAMPLES

A. Preparation for the Underlayer of the Ink Receiving Layer.

A 20 wt. % solution of a lime processed gelatin was prepared at pH 9. An aqueous solution of 10 wt % polyethylene oxide (PEO) having molecular weight of approximately 100 000 (from Sigma Aldrich chemicals, the Netherlands), was also prepared at pH 9. A homogeneous mixture, i.e. no phase separation, of gelatin and PEO having a weight ratio of 6:1 was made by adding 143 weight parts of said PEO solution and 429 weight parts of water into 428 weight parts of said gelatin solution at a temperature of 40° C. This mixture was agitated gently for about 30 minutes.

Mixtures having various gelatin/PEO ratios were made by varying the amount of the above mentioned components, i.e. said gelatin solution, said PEO solution and water. ALL other procedures were kept the same.

In Examples 20-27 the underlayer was divided into several layers in order to have a different gelatin/PEO ratio in each underlayer. For instance in the case of Example 20, underlayer 1-coated on the substrate-contained Gel-PEO ratio (wt./wt.) of 2:1, underlayer 2, coated on the top of underlayer 1, contained a Gel-PEO ratio (wt./wt.) of 2:1 and underlayer 3, coated on the top of underlayer 2, contained a Gel-PEO ratio (wt./wt.) of 6:1.

In Examples 28-33, the PEO has been gradually substituted with another water soluble polymer or a mixture of two water soluble polymers, starting from the underlayer 3. So in the example 28, a mixture of gelatin and water soluble polymers for underlayer 3 was prepared in the weight ratio of 3 to 1. Said water soluble polymers contained 75 wt. % of PEO and 25 wt. % polyvinyl pyrollidone (PVP) having molecular weight of about 30 000 Daltons (ICN Biochemicals). The weight ratio of PEO and PVP in underlayer 3 was decreased in Examples 29 to 31 to respectively 27:75, 50:50 and 0:50. In Example 32, the water soluble polymers for underlayer 1 and underlayer 2 contained also PEO-PVP mixture in the ratio of 50:50. And finally the effect of Gelatin-PVA mixture was given in Example 33.

B. Preparation for the Overlayer of the Ink Receiving Layer.

A solution containing 100 weight parts of modified gelatin (see Table 1) and 900 weight parts of water was prepared at 40° C. The pH of the solution was adjusted to 8.5 by adding NaOH.

C. Coating the Ink Receiving Layers.

The underlayer(s) and overlayer solutions mentioned above were fed into a slide coating machine, commonly known in the photographic industry, and coated on a photographic grade paper having polyethylene laminated at both sides. The flow of the under and overlayers were adjusted such that, after drying, the total solid content of the underlayer(s) (=gelatin+other water soluble polymer) was varied between 8 to 15 g/m² and that of the overlayer was between 0.5 and 5 g/m². After coating, the solution was chilled at a temperature of ca. 12° C. to set the gelatin and then dried with dry air at a maximum temperature of 40° C.

D. Schematic Drawing and Definition of the Layer Structure:

| D-1. Underlayer and | D-2. Multi layer underlayers |
|---|---|
| Overlayer structure | and Overlayer structure |
| Overlayer | Overlayer |
| Underlayer | Underlayer 3 |
| | Underlayer 2 |
| | Underlayer 1 |
| Laminated Substrate | Laminated Substrate |

### Example 1-13

In this set of examples, the effects of the different types of gelatin in the overlayer were investigated.

In Table 1, the type of modification of the gelatin is given. The overlayer formulation as described in B was made for each of the gelatin type. Also four reference media were prepared, Ref. 1-Ref. 4, having the modifications indicated in the table below.

TABLE 1

| Gelatin | | Modification |
|---|---|---|
| type | Type of modification | load [%] |
| A | Dodecyl-succinic modified acid treated gelatin | ca. 40% |
| | from Stoess GmbH, Germany | |
| B | “Croquat L”, a C11 quaternair ammonia modified | 80%-100% |
| | lime, treated gelatin, from Croda Colloids Ltd., | |
| | UK. | |
| C | “Croquat S”, a C18 quaternair ammonia modified | 80%-100% |
| | lime bone gelatin, Croda Colloids Ltd., UK. | |
| D | Lime treated gelatin chemically modified with N- | ca. 40% |
| | Hydroxysuccinimide Ester of Hexanoic acid * | |
| E | Lime treated gelatin chemically modified with N- | ca. 40% |
| | Hydroxysuccinimide Ester of Octanoic acid * | |
| F | Lime treated gelatin chemically modified with N- | ca. 40% |
| | Hydroxysuccinimide Ester of Dodecanoic acid * | |
| G | Lime treated gelatin chemically modified with N- | ca. 40% |
| | Hydroxysuccinimide Ester of hexadecanoic acid * | |

Note:
* these gelatins were obtained by following the procedure described in EP-A-0 576 911 from DuPont and the article described by O. Toledano and S. Magdasi (Journal of Colloid and Interface Science 200, page 235-240 (1998)).

| | Underlayer | | Overlayer | |
|---|---|---|---|---|
| | Gel/PEO | Amount | | Amount |
| | Ratio | gelatin | | coated |
| Example | (wt./wt.) | g/m² | Gelatin type | g/m² |
| 1 | 6:1 | 13 | A | 1 |
| 2 | 6:1 | 10 | A | 5 |
| 3 | 6:1 | 5 | A | 10 |
| 4 | 6:1 | 13 | B | 1 |
| 5 | 6:1 | 13 | Mixture of B and | 1 |
| | | | Conventional Lime treated | |
| | | | gelatin, with ratio 1:3 | |
| 6 | 6:1 | 13 | C | 1 |
| 7 | | | Mixture of C and | 1 |
| | | | conventional Lime treated | |
| | | | gelatin, with ratio 1:1 | |
| 8 | 6:1 | 13 | D | 1 |
| 9 | 6:1 | 13 | E | 1 |
| 10 | 6:1 | 13 | F | 1 |
| 11 | 6:1 | 13 | G | 1 |
| 12 | 6:1 | 5 | B | 3 |
| 13 | 6:1 | 5 | F | 3 |
| Ref. 1 | 6:1 | 13 | Conventional lime treated | 1 |
| | | | gelatin, pH 9 | |
| Ref. 2 | 6:1 | 13 | Conventional acid treated | 1 |
| | | | gelatin, pH 9 | |
| Ref. 3 | 6:1 | 15 | No overlayer | |
| Ref. 4 | 2:1 | 15 | No overlayer | |

### Example 14-19

The effect of the thickness of the Gel-PEO ratio and its ratio in the underlayer on the quality of the ink jet media was investigated in this experimental set up. Also two reference media were prepared, Ref. 5 and 6, having the modifications indicated in the table below.

Underlayer

| | | |
|---|---|---|
| Gel/PEO | Amount | Overlayer |

| | Ratio | gelatin | Gelatin | Amount coated |
|---|---|---|---|---|
| Example | (wt./wt.) | g/m² | type | g/m² |
| 14 | 6:1 | 9 | G | 1 |
| 15 | 6:1 | 12 | G | 1 |
| 16 | 6:1 | 15 | G | 1 |
| 17 | 6:1 | 18 | G | 1 |
| 18 | 4:1 | 13 | A | 2 |
| 19 | 2:1 | 13 | A | 2 |
| Ref. 5 | No | | A | 15 |
| | underlayer | | | |
| Ref. 6 | No | | G | 15 |
| | underlayer | | | |

### Example 20-27

In this set of examples the effect of different gelatin-PEO ratios on print quality was investigated. The underlayer was split-up into 3 layers.

| | | | | | | | Overlayer |
|---|---|---|---|---|---|---|---|
| | Underlayer 1 | | Underlayer 2 | | Underlayer 3 | | Gelatin |
| | Gel/PEO | Solid | Gel/PEO | Solid | Gel/PEO | Solid | type |
| | Ratio | content | ratio | content | ratio | content | [solid |
| Example | (wt./wt.) | g/m² | (wt./wt.) | g/m² | (wt./wt.) | g/m² | content] |
| 20 | 2:1 | 5 | 2:1 | 5 | 6:1 | 4 | A |
| | | | | | | | [2 g/m²] |
| 21 | 2:1 | 5 | 6:1 | 5 | 6:1 | 4 | A |
| | | | | | | | [2 g/m²] |
| 22 | 6:1 | 4 | 6:1 | 4 | 10:1 | 4 | A |
| | | | | | | | [2 g/m²] |
| 23 | 6:1 | 4 | 6:1 | 4 | 4:1 | 4 | A |
| | | | | | | | [2 g/m²] |
| 24 | 6:1 | 5 | 6:1 | 4 | 3:1 | 3 | A |
| | | | | | | | [2 g/m²] |
| 25 | 10:1 | 5 | 6:1 | 4 | 2:1 | 3 | A |
| | | | | | | | [2 g/m²] |
| 26 | 6:1 | 5 | 6:1 | 4 | 2:1 | 3 | C |
| | | | | | | | [2 g/m²] |
| 27 | 6:1 | 5 | 10:1 | 5 | 2:1 | 3 | C |
| | | | | | | | [2 g/m²] |

### Example 28-33

In this set of examples the effect of the mixture of gelatin with various water soluble polymer(s) on the print quality was investigated. The underlayer was split-up into 3 layers.

| | Underlayer 1 | | Underlayer 2 | | Underlayer 3 | | Overlayer |
|---|---|---|---|---|---|---|---|
| | Gel/Water | | Gel/Water | | Gel/Water | | Gelatin |
| | soluble | Solid | soluble | Solid | soluble | Solid | type |
| | polymer | content | polymer | content | polymer(s) | content | [solid |
| Example | (wt./wt.) | g/m² | (wt/wt.) | g/m² | (wt./wt.) | g/m² | content] |
| 28 | Gel:PEO = 6:1 | 5 | Gel:PEO = 6:1 | 4 | GEL:(PEO-PVP) = 3:1 | 3 | A |
| | | | | | (PEO:PVP = 75:25) | | [2 g/m²] |
| 29 | Gel:PEO = 6:1 | 5 | Gel:PEO = 6:1 | 4 | GEL:(PEO-PVP) = 3:1 | 3 | A |
| | | | | | (PEO:PVP = 25:75) | | [2 g/m²] |
| 30 | Gel:PEO = 6:1 | 5 | Gel:PEO = 6:1 | 4 | GEL:(PEO-PVP) = 3:1 | 3 | A |
| | | | | | (PEO:PVP = 50:50) | | [2 g/m²] |
| 31 | Gel:PEO = 6:1 | 5 | Gel:PEO = 6:1 | 4 | GEL:PVP = 3:1 | 3 | A |
| | | | | | | | [2 g/m²] |
| 32 | GEL:(PEO-PVP) = 3:1 | 5 | GEL:(PEO-PVP) = 3:1 | 4 | GEL:(PEO-PVP) = 3:1 | 3 | A |
| | (PEO:PVP = 50:50) | | (PEO:PVP = 50:50) | | (PEO:PVP = 50:50) | | [2 g/m²] |
| 33 | Gel:PEO = 6:1 | 5 | Gel:PEO = 6:1 | 4 | Gel:PVA = 3:1 | 3 | A |
| | | | | | | | [2 g/m²] |

### Example 34-40

In this set of examples, the effect of surfactants on the print quality was analysed.

The surfactant was added in the overlayer in the amount of between 0.5 wt % and 2 wt % of the dry gelatin amount. Several kind of surfactants were purchased for these examples.

Several types of Zonyl® surfactants (a fluoro-carbon type of surfactant), were purchased from DuPont, USA. Aerosol OT was purchased from Nippon Yushi, Japan and Sodium Dodecyl Benzene Sulphonate (SDBS) was obtained from ICN Biochemiclas, USA. Aerosol OT and SDBS are anionic hydrocarbon type surfactants. Another fluorosurfactant having the following chemical name was also tested: 1,4-bis(nona-fluoro-hexyl)-2-[2-(N,N,N-trimethyl-ammonium)ethylamino]-butanedioate p-toluenesulfonate (=FHTB).

For the evaluation of the effect of the different surfactant type, the ink jet media was also printed with Canon i950. The selected settings for the printer is:

Media type: Photo Paper Plus Glossy

Print quality: diffusion

All other settings are adjusted according to the factory setting.

| | Underlayer | | Overlayer | | |
|---|---|---|---|---|---|
| | Gel/PEO | Solid | | Solid | |
| | Ratio | content | Gelatin | content | Surfactant |
| Example | (wt./wt.) | g/m² | type | g/m² | type |
| 34 | 5: [symbol] | 13 | B | 2 | Zonyl ® FSA |
| 35 | 5:1 | 13 | B | 2 | Aerosol OT |
| 36 | 5:1 | 13 | F | 2 | SDBS |
| 37 | 6:1 | 13 | G | 2 | Zonyl ® FSA |
| 38 | 6:1 | 13 | A | 2 | FHTB |
| 39 | 6:1 | 13 | A | 2 | Zonyl ® FSO |
| 40 | 6:1 | 13 | A | 2 | Zonyl ® FSN |

E. Evaluation of the Printed Image on the Media

The ink jet media prepared by the above mentioned formulation and said coating process, were printed with a standard image comprising black, cyan, magenta and yellow bars. The image contained also two pictures; including a portrait picture and a composition picture. The image was printed at a room conditions (23° C. and 48% Relative Humidity (RH)) and the printed materials were kept at this condition for at least 1 hour to dry.

A HP Deskjet® 995c was used to print the images by using the following settings:
Print quality: best
Selected Paper type: HP premium plus photo paper, glossy
Other parameters were according to the factory setting.

The quality of the printed images were further analysed visually by analysing the beading behaviour, the glossiness of especially the black area, the dryness of especially the black area, and the bleeding behaviour after some period of time.

F. Definitions of the Image Evaluation

1. Beading Behaviour

As set out hereinabove, beading is defined as the phenomenon that large ink dots that become visible on the printed image. The following classification has been defined:

◯: no beading is observed

Δ: some small spots which is not very visible and/or beading that can be solved by selecting another printer settings.

X: Clearly visible

2. Glossiness after Printing.

The glossiness of the image directly after printing and after two days were analysed by observing the reflection of light on the high density area of the print (e.g. black colour), The more reflection was observed, the glossier the printed image. The following classification was defined for judging the Glossiness:

◯: Still glossy after 2 days without any defects

Δ: Gloss after printing, but after 2 days some “matte” spots was observed.

X: Matte appearance after printing, or a lot of “matte” spots after 2 days.

3. Dryness

The dryness of the image was analysed by putting 10 sheets of A-4 white paper on the printed image for about 30 minutes.

◯: Good drying=no ink transfer observed on the white paper

Δ: Acceptable=some vague (low density) ink transfer X:. Bad=ink transfer was clearly visible

4. Bleeding Behaviour.

For this analysis, the printed images were further conditioned at a temperature of 25° C. and 90% relative humidity for 2 days. Thereafter, the images were analysed visually for colour diffusion.

◯: No colour diffusion is observed.

Δ: Acceptable. The result is not bad but also not perfect.

X: Clear colour diffusion.

Results of example 1-13. Effect of different modified gelatin type.

| Example | Beading | Glossiness | Dryness | Bleeding |
|---|---|---|---|---|
| 1 | ◯ | ◯ | ◯ | ◯ |
| 2 | ◯ | ◯ | ◯ | ◯ |
| 3 | Δ | ◯ | ◯ | ◯ |
| 4 | ◯ | ◯ | Δ | ◯ |
| 5 | ◯ | ◯ | ◯ | ◯ |
| 6 | Δ˜◯ | ◯ | Δ | ◯ |
| 7 | ◯ | ◯ | Δ | ◯ |
| 8 | ◯ | ◯ | ◯ | ◯ |
| 9 | ◯ | ◯ | Δ˜◯ | ◯ |
| 10 | ◯ | ◯ | ◯ | ◯ |
| 11 | Δ˜◯ | ◯ | ◯ | ◯ |
| 12 | ◯ | ◯ | ◯ | ◯ |
| 13 | ◯ | ◯ | ◯ | ◯ |
| Ref. 1 | X | ◯ | X | ◯ |
| Ref. 2 | X | ◯ | X | ◯ |
| Ref. 3 | Δ | ◯ | X | ◯ |
| Ref. 4 | ◯ | X | ◯ | X |

Examples 14-19. Effect of thickness of under and overlayer

| Example | Beading | Glossiness | Dryness | Bleeding |
|---|---|---|---|---|
| 14 | ◯ | ◯ | ◯ | ◯ |
| 15 | ◯ | ◯ | ◯ | ◯ |
| 16 | ◯ | ◯ | ◯ | ◯ |
| 17 | ◯ | ◯ | ◯ | ◯ |
| 18 | ◯ | ◯ | ◯ | ◯˜Δ |
| 19 | ◯ | ◯ | ◯ | Δ |
| Ref 5 | X | ◯ | Δ˜X | ◯ |
| Ref. 6 | X | ◯ | Δ˜X | ◯ |

Result of Example 20-27. Effect of gelatin-PEO ratio in the underlayer

| Example | Beading | Glossiness | Dryness | Bleeding |
|---|---|---|---|---|
| 20 | i˜◯ | ◯ | ◯ | Δ |
| 21 | Δ | ◯ | ◯ | ◯ |
| 22 | Δ | ◯ | Δ | ◯ |
| 23 | ◯ | ◯ | ◯ | ◯ |
| 24 | ◯ | ◯ | ◯ | ◯ |
| 25 | ◯ | ◯ | ◯ | ◯ |
| 26 | ◯ | ◯ | ◯ | ◯ |
| 27 | ◯ | ◯ | ◯ | ◯ |

Result of Example 28-33. Effect of mixture between gelatin with various water soluble polymers

| Example | Beading | Glossiness | Dryness | Bleeding |
|---|---|---|---|---|
| 28 | ◯ | ◯ | ◯ | ◯ |
| 29 | ◯ | ◯ | ◯ | ◯ |
| 30 | ◯ | ◯ | ◯ | ◯ |
| 31 | ◯ | ◯ | ◯ | ◯ |
| 32 | ◯ | ◯ | ◯ | ◯ |
| 33 | ◯ | ◯ | ◯ | ◯ |

Result of Example 34-40. Effect of surfactant

| | Beading | Beading |
|---|---|---|
| Example | HP 995 | Canon i 950 |
| 34 | ◯ | ◯ |
| 35 | ◯˜Δ | Δ˜X |
| 36 | ◯˜Δ | Δ |
| 37 | ◯ | ◯ |
| 38 | ◯ | ◯ |
| 39 | ◯ | ◯ |
| 40 | ◯ | ◯ |

In all inventive examples (Example 1-40), the printers were equipped with their original ink. From the result of Examples 34 to 40 it may be concluded that beading behaviour is strongly related to the type of printer and/or the amount and type of ink. However, as it is shown in the example, the presence of fluoro-surfactant in the overlayer improves the beading behaviour.

1. A recording medium comprising a support and an ink-receiving layer adhered to said support, wherein the ink receiving layer is a multilayer comprising at least one underlayer and at least one overlayer in which at least one overlayer comprises at least one type of modified gelatin, wherein said modified gelatin is modified by: a condensation reaction with a succinic acid moiety containing an aliphatic chain from at least 5 to 20 carbon atoms; by reacting gelatin with N-hydroxysuccinimide ester of C₄-C₁₆ fatty acids; or C₅-C₂₅ alkyl quaternary ammonium modified gelatin.

2. The medium according to claim 1, wherein said modified gelatin comprises a C₇-C₁₈ alkyl group or a C₇-C₁₈ fatty acid group.

3. The medium according to claim 1 in which the modified gelatin is used in an amount of 0.5 to 5.0 g/m².

4. The medium according to claim 1 in which the overlayer further comprises at least one water soluble polymer.

5. The medium according to claim 4 in which the water soluble polymer is a member selected from the group consisting of fully or partially hydrolyzed polyvinyl alcohol, hydroxyethyl cellulose, methyl cellulose, hydroxypropyl cellulose, polyvinylpyrrolidone, lime processed gelatin, acid processed gelatin, polyethylene oxide, polyacrylamide, and mixtures thereof.

6. The medium according to claim 5 in which the water soluble polymer is polyvinylpyrrolidone, lime processed gelatin, acid processed gelatin, or a combination thereof.

7. The medium according to claim 1 in which a water soluble polymer is present in the overlayer in an amount from 0 to 75 wt. % of the amount of the modified gelatin.

8. The medium according to claim 1 in which the overlayer further comprises at least one fluoro-surfactant selected from the group of Li, K and Na-N-perfluoro C₄-C₁₃ alkane sulfonyl-N-alkyl glycine, 1,4-bis(fluoroalkyl)-2-[2-N,N,N-trialkylammonium)alkyl amino] butanedioate, and fluorosurfactants having the chemical structure of R_{f}CH₂CH₂SCH₂CH₂CO₂Li or R_{f}CH₂CH₂0(CH₂CH₂0)χH wherein R_{f}═F(CF₂CF₂)₃₋₈ and χ=0 to 25.

9. The medium according to claim 8, wherein the amount of fluoro-surfactant is from 2.5 to 250 mg/m².

10. The medium according to claim 1 in which the underlayer further comprises at least a mixture of gelatin and a water soluble polymer with a weight ratio of 10:1 to 1:1.

11. The medium according to claim 10, wherein the underlayer comprises a multilayer, wherein in each of the layer making up the multilayer, the gelatin/water soluble polymer weight ratio of each layer varies between 10:1 to 1:1.

12. The medium according to claim 13, wherein each layer of said multilayer contains different ratio of gelatin/water soluble polymer, wherein the lower ratio of gelatin/water soluble polymer is in the layer farthest away from the support compared to said ratio in the layer near to the support.

13. The medium according to claim 10, wherein said gelatin in the underlayer is a member selected from alkali-treated gelatin, acid-treated gelatin, gelatin derivatives like acetylated gelatin, phthalated gelatin, quaternary ammonium modified gelatin, and mixtures thereof.

14. The medium according to claim 15, wherein the gelatin is alkali-treated gelatin or acid-treated gelatin with an iso-electric point between 4 and 11.

15. The medium according to claim 10, wherein said water soluble polymer is a member selected from fully hydrolyzed or partially hydrolyzed polyvinyl alcohol, hydroxyethyl cellulose, methyl cellulose, hydroxypropyl cellulose, polyethylene oxide, polyacrylamide, polyvinylpyrrolidone, and mixtures thereof.

16. The medium according to claim 15, wherein said water soluble polymer is polyethylene oxide (PEO), polyvinylpyrrolidone, or a mixture thereof.

17. The medium according to claim 16, in which the molecular weight of the polyethylene oxide or polyvinylpyrrolidone is between 30,000 and 600,000.

18. The medium according to claim 10, wherein the amount of said gelatin is from 1 to 30 g/m².

19. The medium according to claim 1, wherein said ink receiving layer has a thickness of between 1 to 50 μm.

20. The medium according to claim 1, wherein a crosslinking agent is added in an amount of from 0.1 to 10 g per 100 g of gelatin.

21. The medium according to claim 20, wherein the crosslinking agent is a member selected from the group consisting of triazines, vinyl sulfonyl compounds, and mixtures thereof.

22. A process for producing a recording medium, comprising the steps of:
preparation of at least one mixture for an underlayer;
preparation of at least one mixture comprising at least a gelatin dissolved in water, which gelatin is modified by a condensation reaction with a succinic acid moiety containing an aliphatic chain from at least 5 to 20 carbon atoms; by reacting gelatin with N-hydroxysuccinimide ester of C₄-C₁₆ fatty acids; or is C₅-C₂₅ alkyl quaternary ammonium modified gelatin for the overlayer; and
coating said mixtures consecutively or simultaneously on a support, followed by drying the coated support.

23. The process according to claim 22, wherein said underlayer and said overlayer are coated consecutively or simultaneously on a substrate using curtain coating, extrusion coating, air-knife coating, slide coating, a roll coating method, reverse roll coating, dip coating processes or a rod bar coating, and then dried.

24. The recording medium obtainable by the process of claim 22.

25. The recording medium according to claim 1, wherein said support is a member selected from the group consisting of paper, a photographic base paper, a synthetic paper and a film substrate.

26. The recording medium according to claim 1, wherein said recording medium is an inkjet recording medium, Giclée printing recording medium, color copying recording medium, screen printing recording medium, gravure recording medium, dye-sublimation recording medium or flexography recording medium.

27. A method of forming a permanent, precise ink-jet image comprising the steps of:
providing an ink-jet recording medium as defined in claim 1; and
bringing the ink-jet ink into contact with the medium in the pattern of a desired image.

28. The medium according to claim 16, in which the molecular weight of the polyethylene oxide or polyvinylpyrrolidone is between 50,000 and 400,000.

29. The medium according to claim 10, wherein the amount of said gelatin is from 0.2 to 20 g/m².

30. The medium according to claim 1, wherein a crosslinking agent is added in an amount of from 0.1 to 7 g per 100 g of total gelatin amount.
